(19) United States
(12) Patent Application Publication
(10) Pub. No.: US 2026/0029063 A1
(43) Pub. Date: Jan. 29, 2026

(54) PNEUMATIC VALVE

(71) Applicant: Conti Temic microelectronic GmbH, Ingolstadt (DE)

(72) Inventors: Michael Beuschel, Stammham (DE); Alexander Kerler, Titting (DE); Jürgen Wedell, Rastatt (DE); Andreas Mages, Nürnberg (DE)

(73) Assignee: Conti Temic microelectronic GmbH, Ingolstadt (DE)

(21) Appl. No.: 19/099,300

(22) PCT Filed: Jul. 12, 2023
(86) PCT No.: PCT/DE2023/200143

§ 371 Date: Jan. 28, 2025

(30) Foreign Application Priority Data
Jul. 29, 2022 (DE) 10 2022 207 882.9

(51) Int. Cl. F16K 31/02; B60N 2/90; F16K 15/18

(52) U.S. Cl. CPC F16K 31/025; B60N 2/914; B60N 2/976; F16K 15/182

(57) ABSTRACT

A pneumatic valve features a housing with an air chamber including a supply opening for compressed air, a connecting opening to an air cushion, and a discharge opening. An actuator with a movable closing element, comprising a plunger and a plate with a first sealing element, is positioned within the housing. The actuator includes a circuit board, an actuating element with an actuating portion and a bending portion, and a shape memory actuator element. In a non-energized state, the actuator element positions the actuating element to press the plunger against the supply opening, while in an energized state, it allows the first sealing element to close the discharge opening via an elastic element. A second sealing element closes the supply opening in a non-energized state and opens it under positive pressure when energized. A third sealing element, elastically connected to the second, closes the supply opening under non-positive pressure conditions.

### DESCRIPTION

The invention relates to a pneumatic valve, having a housing in which an air chamber with a supply opening for supplying compressed air into the air chamber, a connecting opening for connecting the air chamber to an air cushion and a discharge opening for discharging compressed air from the air chamber is formed, wherein an actuator with a movable closing element is arranged in the housing, wherein the closing element is formed with a plunger, which projects through the discharge opening and has formed at the portion thereof projecting into the air chamber a plate on which a first sealing element for closing the discharge opening is arranged, and with an elastic element which, in the activated state of the pneumatic valve, presses said sealing element against the discharge opening. The actuator also has a circuit board, an actuating element which has an actuating portion for acting on the plunger and a bending portion connected to the actuating portion and to the circuit board, and an actuator element which has a first end mechanically connected to the actuating portion and a second end mechanically and electrically connected to the circuit board, wherein the actuator element is designed to, in a non-energized state, bring the actuating element to a first state in which it presses the plunger against the supply opening, and to, in an energized state, bring the actuating element to a second state in which the actuating portion does not exert any force on the plunger, with the result that the discharge opening is closed by the first sealing element owing to the action of the elastic element.

Such a pneumatic valve is known from DE 10 2018 216 874 A1, DE 2018 216 876 A1 and also from DE 10 2019 208 051 A1. However, in the case of those valves, fluid bladders or air cushions connected to the connecting opening are emptied in the activated state of the valves when there is a pressure drop at the supply opening, for example when the compressor is switched off, since there is an open connection between the connecting opening and the supply opening.

In means of transportation, fillable elastic cushions are used to shape seat contours. For this purpose, the elastic cushions are usually filled with air. Electrically actuated valves are used to control the air. By means of periodic filling and emptying the cushions, they can be used even for a massage function. For the massage function, two or more air cushions are activated and can be adjusted independently of one another or else can remain in a filled state while other cushions are filled or vented. Due to the short holding time of the air in a cushion when being used for massage (a few seconds to approx. 10 min) compared with a contour adjustment, NO (normally open) valves are usually used for this purpose, which are in a venting position in the non-actuated state.

Even mid-range and low-end vehicles are increasingly being equipped with such systems. Therefore, a design which is as cost-effective as possible is required. At the same time, vehicles are designed with a view to saving weight in order to meet environmental and consumption requirements. This results, inter alia, in a more compact construction of seats. This also means that the components installed therein have to be reduced in size.

In many embodiments such as for pneumatic lumbar supports, independent 2/2-way valves are used for filling and venting for each cushion installed in a vehicle seat; consequently, each cushion requires two valve actuators. As an alternative, a combination such as 3/3-way or 3/4-way valves (likewise with two actuators) can be used for this instead of two 2/2-way valves. Shape memory alloy (SMA) elements, which have a particularly high power density, are increasingly used as actuators for pneumatic valves.

DE 10 2013 220 563 A1 describes a solution in which the cushions are divided into multiple groups which each use a 2/2-way or 3/2-way pilot valve, thus resulting in a degree of independence—albeit limited. A further 2/2-way valve then suffices for each cushion. Cushions from groups which differ from one another can thus be independently adjusted.

EP 2 361 800 B1 discloses a pneumatic circuit which uses 3/2-way switching valves with check valves connected upstream. This makes it possible to halve the number of valve actuators required. The check valves and the switching valves here are self-contained components which are connected to one another by additional connection parts. The arrangement is integrated in a compressor housing.

DE 10 2017 213 736 B3 discloses a further development thereof, in which the check valve is embodied as part of the electromagnetic switching valve and closes tightly upon actuation.

DE 10 2011 102 701 B4 describes a valve block with a pressure relief valve, which is constructed separately but with similar parts to the switching valves.

DE 10 2017 213 744 B3 describes an NC valve (NC; normally closed) with an integrated check valve, which closes firmly when actuated. The associated SMA actuator is located in the pressure region of the working port (cushion).

DE 10 2018 112 090 A1 uses a shape memory wire as a light and compact valve actuator. Moreover, a check valve in the form of an elastic disk, which is arranged on the opposite side of the filling valve seat, is used here. The SMA actuator and circuit board are located here in the pressure region of the feed air duct.

German application 10 2022 202 438.9, which is not a prior publication, discloses a massage valve with an SMA actuator, which is likewise arranged outside the pressure chamber. The sealing element assigned to the supply opening is simultaneously used as a check valve. A disadvantage here is that the valve seat of the sealing element at the discharge opening requires a higher spring force for sealing purposes, whereas the valve seat at the supply opening requires a low spring force in order to minimize the opening pressure at the supply or check valve during the filling of a cushion by a supply of compressed air.

In a first variant there, the spring force acts only on the sealing element at the discharge opening, that is to say on the vent valve, while the sealing element at the supply opening, that is to say the integrated check valve, is virtually force-free in the actuated state of the actuator. This brings about a high leakage at the check valve, in particular in the case of a decreasing internal material stress of the sealing element and in the case of a low air pressure in the cushion to be filled.

In a second variant, the elastic element which is in the form of a spring simultaneously also acts on the check valve. In this case, the sealing line force required for reliable sealing results, during the filling, in an opening pressure or a pressure loss lying in the range of the working pressure. At a force of 0.1 N and an assumed nozzle circumference of 5 mm, the sealing line force is 0.1 N/5 mm=0.02 N/mm. At a nozzle area of 2 mm², this corresponds to an opening pressure of 0.1 N/2 mm²=500 hPa. This reduces the efficiency of the arrangement, since this pressure has to be additionally applied by the pressure supply. If, by contrast, the spring is configured with a very low force, the leakage at the vent valve in the actuated state of the actuator is also considerable.

As a remedy, two spring elements of differing strength would have to be used (that is to say, for example, a combination of the two embodiments), which would lead to additional component and installation costs.

In DE 10 2021 203 190 A1, which is likewise not a prior publication, the actuator element is designed to, in an energized state, bring the actuating element to a first state in which it presses the plunger against the supply opening, and to, in a non-energized state, bring the actuating element to a second state in which the actuating portion does not exert any force on the plunger, with the result that the discharge opening is closed by the first sealing element owing to the action of the elastic element. However, only an escape of compressed air in the non-activated state of the valve is prevented by this means.

The object of the invention is to specify a pneumatic NO valve with an SMA actuator at ambient pressure and an integrated check valve for largely independent control of multiple massage air cushions, said NO valve being as simple, space-saving and cost-effective as possible. At the same time, the opening pressure when the flow passes through the check valve is thus also intended to minimize the leakage at the discharge opening without increasing the number of required components.

The object is achieved by a pneumatic valve as claimed in claim 1. Advantageous developments are specified in the dependent claims.

Accordingly, in a pneumatic valve of the type in question, a second sealing element is arranged in the air chamber, said second sealing element, in the non-energized state of the actuator element, closing the supply opening and, in the energized state of the actuator element, opening the supply opening in the event of a positive pressure difference between the pressure at the supply opening and the pressure at the connecting opening and closing the supply opening in the event of a non-positive pressure difference between the pressure at the supply opening and the pressure at the connecting opening. The second sealing element in the air chamber thus realizes an integrated check valve in a simple manner. Furthermore, a third sealing element is arranged in the air chamber, said third sealing element being elastically connected to the second sealing element and being arranged downstream of the second sealing element in a flow direction of the compressed air from the supply opening to the connecting opening, wherein the elastic element acts directly on the third sealing element and via the elastic connection on the second sealing element. In the case of a non-positive pressure difference between the pressure at the supply opening and the pressure at the connecting opening, the third sealing element likewise closes off the supply opening.

When the valve is actuated, the check valve realized by the third sealing element prevents or at least minimizes a flow directed counter to the air cushion filling direction. The check valve is arranged such that it, when the valve is actuated, is drawn or pressed against a third sealing seat of the third sealing element at the supply opening by a flow in the opposite direction. This movement can also be effected by an internal restoring force, such as a material stress in an elastomer of which the third sealing element, e.g. in the form of a spherical cap, can consist, by the third sealing element being pressed lightly against the third sealing seat at the supply opening. As an alternative or in addition, this may also be effected by an external restoring force, for example as a result of a spiral spring, resulting in the third sealing element being pressed against the third sealing seat at the supply opening.

When the pneumatic valve is not actuated, the second sealing element is pressed by a plunger onto a first sealing seat of the supply opening and seals it. The second sealing element may be made of a thin and rigid or elastic material, which has a counterpart contour with respect to the sealing seat or can be brought into this form upon abutment against the sealing seat.

What is thus described is a 3/2-way valve in pot form which is actuated by an SMA actuator by means of a plunger through the discharge opening. At that portion of the plunger which projects into the air chamber, said plunger has a sealing element. In the activated state, the actuator releases the plunger, as a result of which the latter is then pushed by the (low) force of a restoring spring from the supply opening to the discharge opening. The first sealing element thus seals the discharge opening, preferably by being pressed against a first sealing seat at the discharge opening.

In the non-activated state of the valve, the actuator presses the plunger into the lower position. The plunger thus exerts a force downward on the second sealing element and thus seals the supply opening, preferably by being pressed against a second sealing seat at the supply opening. In this way, no air can flow into the cushion even in the case of high pressure in the feed air duct. At the same time, the discharge opening or the vent valve opens.

In the activated state, the plunger moves to the upper position and thus releases the check valve and therefore the supply opening. If the pressure in the feed air duct is now greater than the pressure in the valve chamber, the second sealing element at least partially lifts off from the second sealing seat and the third sealing element also lifts off from a third sealing seat, and air can flow through the supply opening. The third sealing element is arranged downstream of the second sealing element in the supply flow direction, the third sealing seat being formed on the housing around the second sealing seat-preferably concentrically.

If, in the activated state, the pressure in the feed air duct then decreases rapidly below the pressure of the previously filled cushion (as a result of the compressor being switched off or as a result of another valve being opened), a backflow from the air chamber into the feed air duct occurs. This flow generates suction, as a result of which the second and the third sealing element again bear against the second and third sealing seat, respectively, and thus the check valve closes the supply opening. This prevents a backflow, and the air is held in the air chamber or in the cushion as long as the valve remains in the activated state.

In addition, the check valve is pressed lightly onto the sealing seat by a spring force—and thus independently of a backflow—and likewise prevents a backflow as a result. The sealing force of the check valve is applied by the restoring spring and additionally by the pressure difference and increases with the latter. Consequently, there is also a higher tightness in the case of a high pressure difference than in the case of a low pressure difference. Owing to the short holding times in the case of massage valves in the range of a few seconds to a few minutes, a leak that may arise as a result can be tolerated in the case of a low pressure difference.

Any pressure loss resulting from leaks can largely be compensated under the following condition: If further cushions are filled while the leak-afflicted one is being held, the feed air flows not only into the cushion to be newly filled but also into the held cushion as soon as the pressure in the feed air duct becomes greater than that in the held cushion.

In order to achieve a rapid pressure drop in the feed air, it is also possible for the valve of an empty cushion which is not being used at that moment to be briefly opened when the compressor is switched off. As a result, the residual pressure in the feed air duct escapes rapidly, thus producing the suction required for abutment of the check valve.

In an advantageous embodiment of the pneumatic valve, the area spanned by the third sealing element is significantly larger than the area of the second sealing element or the area of the first sealing element.

In one variant of the pneumatic valve, the elastic element is a spiral spring.

In a first embodiment of the pneumatic valve, the elastic connection is formed by a bead of U-shaped cross section which runs around the second sealing element and runs within the third sealing element.

This bead connects the second sealing element to the third sealing element in such a way that the overall sealing element formed as a result is airtight and the third sealing element can be moved against the second sealing element owing to the U-shaped cross section.

In a second embodiment of the pneumatic valve, the second sealing element, the third sealing element and the elastic connection thereof are formed integrally as a spherical cap.

The invention is described in more detail below on the basis of exemplary embodiments with the aid of figures. In the figures:

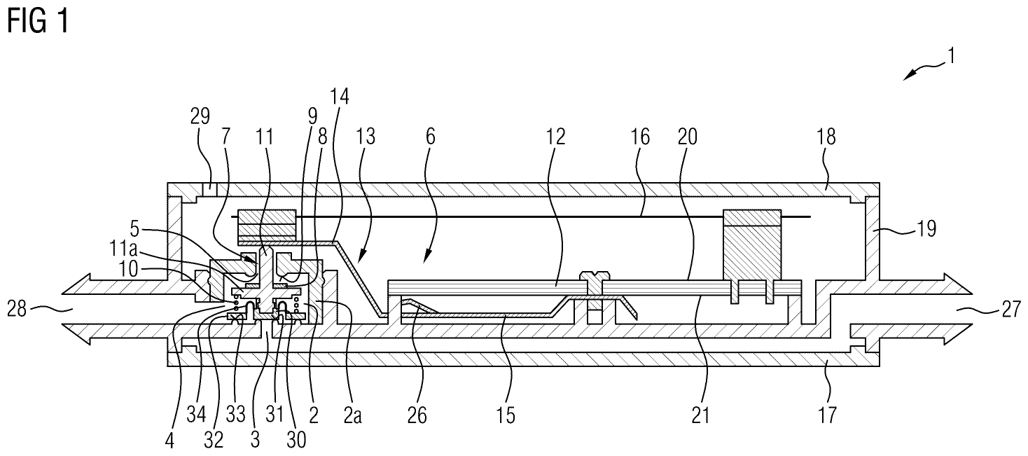

FIG. 1 shows a first embodiment variant of a pneumatic valve according to the invention in a non-actuated state,

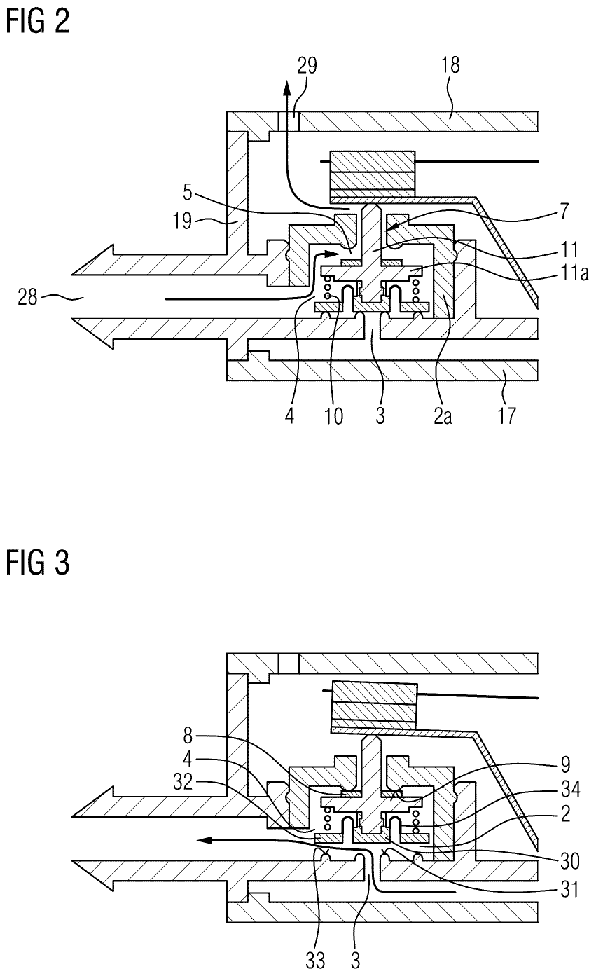

FIG. 2 shows a detailed view of the first embodiment variant of the valve in the non-actuated state during a venting operation,

FIG. 3 shows a detailed view of the first embodiment variant of the valve in the actuated state during a filling operation,

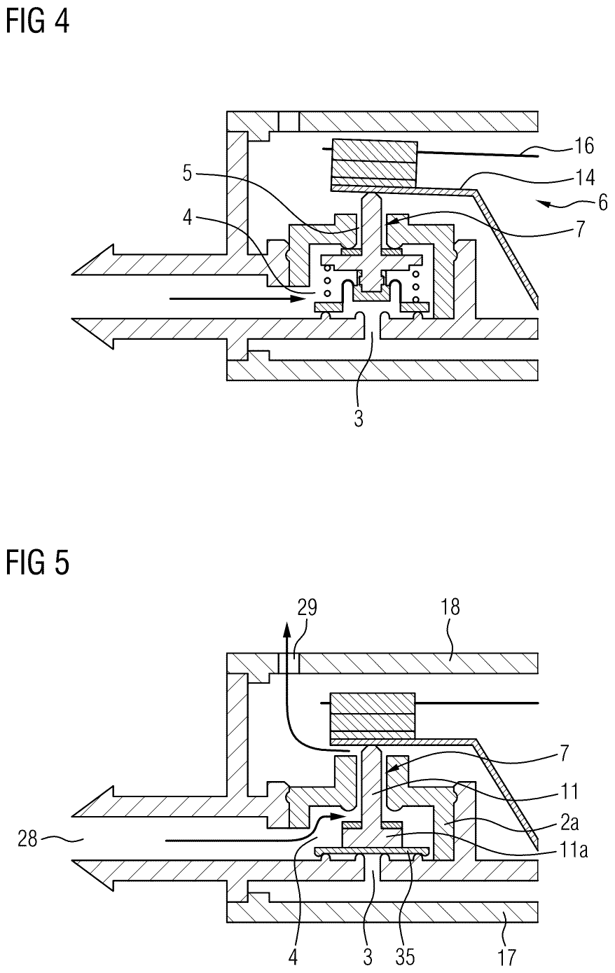

FIG. 4 shows a detailed view of the first embodiment variant of the valve in the actuated state, after a filling operation, with an active restoring valve,

FIG. 5 shows a detailed view of a second embodiment variant of the valve in the non-activated state during a venting operation,

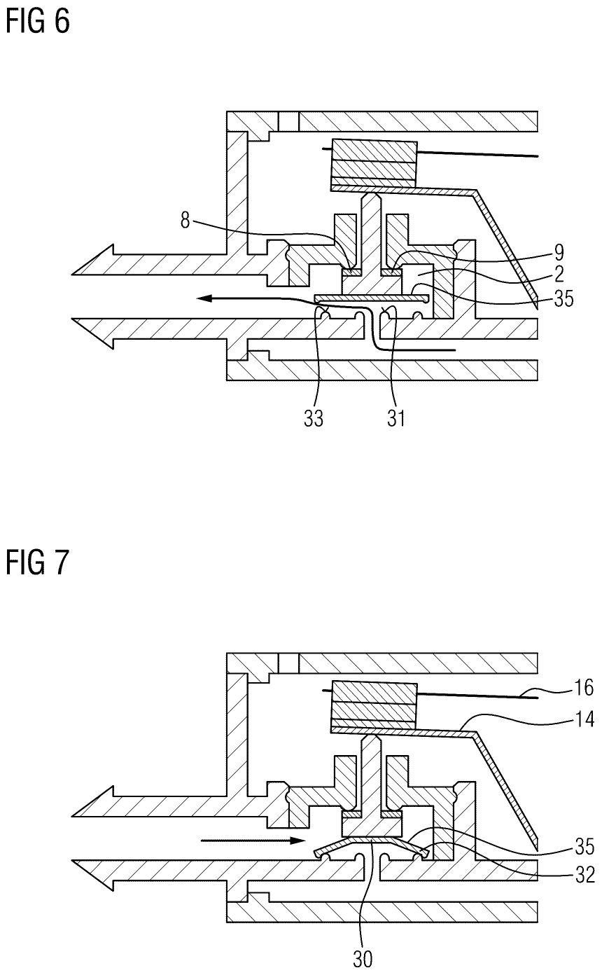

FIG. 6 shows a detailed view of the second embodiment variant of the valve in the actuated state during a filling operation, and

FIG. 7 shows a detailed view of the second embodiment variant of the valve in the actuated state, after a filling operation, with an active restoring valve.

FIG. 1 shows a cross-sectional illustration of a first exemplary embodiment of a pneumatic valve, which is formed with a housing 1, which has a first housing part 17, which is designed as a base plate in the illustrated exemplary embodiment. The housing 1 also has a second housing part 18 which is in the form of a cover, and lastly a third cup-shaped housing part 19 which is in the form of an insert part between the first and the second housing part 17, 18 and on which a supply port 27 and a connecting port 28 are integrally formed.

An air chamber 2 is formed on the third housing part 19, in that the latter has a pot-shaped molding into which a terminating part 2a is inserted as a cover of the air chamber 2. The air chamber 2 has a supply opening 3, a connecting opening 4 and a discharge opening 5. In the illustrated exemplary embodiment, the supply opening 3 and the connecting opening 4 are formed in the third housing part 19, and the discharge opening 5 is formed in the terminating part 2a terminating the air chamber 2.

It is thus possible for compressed air to be routed, for example from a compressor, via the supply port 27 into the housing 1, wherein the compressed air can pass via the supply opening 3 into the air chamber 2 and from there via the connecting opening 4 and the connecting port 28 into an air cushion connectable thereto.

On the other hand, compressed air from the air cushion can pass via the connecting port 28 and the connecting opening 4 into the air chamber 2 and from there via the discharge opening 5 into the interior of the housing 1, there being an opening 29 to the environment there.

In the air chamber 2, a closing element 7 with a plunger 11 and with a first sealing element 8 is formed, wherein the first sealing element 8 is fastened to or integrally formed on a plate 11a which is connected to or integrally formed on that end of the plunger 11 which projects into the air chamber 2. A first sealing seat 9, against which the first sealing element 8 can be pressed so as to close the discharge opening 5, is integrally formed or arranged around the discharge opening 5 on the terminating part 2a.

In the air chamber 2, a second sealing element 30 is arranged at the end of the plunger 11 between the plunger 11 and the supply opening 3. The second sealing element 30 is preferably formed from an elastic material and, in the non-activated state of the pneumatic valve, presses onto a second sealing seat 31, which is arranged around the supply opening 3, preferably is integrally formed on the third housing part 19, as a result of which the supply opening 3 is sealed in the event of a certain force on the second sealing element 30.

In the non-activated state of the valve shown in FIG. 1, the closing element 7 presses on the second sealing element 30 and thus presses the latter against the supply opening 3. This makes it possible for air in an air cushion connected to the connecting port 28 to escape via the non-closed discharge opening 5 through the opening 29 in the second housing part 18, thus producing an NO valve.

Moreover, an actuator 6 is arranged in the housing 1. The actuator 6 is formed with a circuit board 12 which is mounted on and mechanically connected to corresponding struts of the third housing part 19. Connected to the circuit board 12 is an actuating element 13 which has an actuating portion 14 in direct contact with the plunger 11 and has a bending portion 15 connected to the circuit board 12.

The actuator 6 also has an actuator element 16, which is preferably formed with a wire that is composed of a shape memory alloy and contracts when current supplied by a circuit (not illustrated) on the circuit board 12 is applied thereto. In the non-activated state, the actuating element 13 is preloaded in such a way that the actuating portion 14 of the actuating element 13 presses against the closing element 7 or the plunger 11 and thus presses the second sealing element 30 counter to the force of an elastic element 10 onto the supply opening 3, as a result of which the discharge opening 5 is opened.

The actuator element 16 is connected both to the actuating element 13 and to the circuit board 12—for example by means of crimp connections.

Advantageously, the actuator element 16 is formed above an upper side 20 of the circuit board 12 and the actuating element 13 is formed below a lower side 21 of the circuit board 12, such that a very compact construction results. In principle, the structure can also be mirror-inverted, such that the actuator element 16 comes to lie below the circuit board 12 and the actuating element 13 comes to lie above the circuit board 12.

Advantageously, an end position detection element 26 is formed on the actuating element 13, said end position detection element coming into contact with the circuit board 12 when the actuator 6 is actuated and enabling a current flow, as a result of which it is detected that the end position has been reached, with the result that the current can be switched off or at least reduced by the actuator element 16 in order not to overload the latter.

In FIG. 1, a third sealing element 32 is arranged in the air chamber 2. The third sealing element 32 is connected to the second sealing element 30 via an elastic connection, wherein the overall sealing element composed of the second sealing element 30, the third sealing element 32 and the elastic connection forms a unit and is impermeable to air.

Around the second sealing seat 31, a third sealing seat 33 is arranged on the third housing part 19, in particular integrally formed thereon. In the inactive state of the pneumatic valve, the third sealing element 32 is pressed against the third sealing seat 33 by the elastic element 10. Here, the elastic element 10 is clamped between the plate 11a arranged on the plunger 11 and the third sealing element 32. In the exemplary embodiment of FIG. 1, it is formed by a spiral spring.

In the exemplary embodiment of FIG. 1, the elastic connection is embodied with a U-shaped bead, as a result of which the second sealing element 30 and the third sealing element 32 can move relative to one another.

As a result of the arrangement of the third sealing element 32 around the second sealing element 30, air flowing into the air chamber 2 through the supply opening 3 first passes through a gap between the second sealing seat 31 and the second sealing element 30 and only then passes through a gap between the third sealing seat 33 and the third sealing element 32.

In the case of a higher pressure in the air chamber 2 in relation to the supply duct at the supply port 27, in particular the third sealing element 32 is pressed against the third sealing seat 33 owing to this positive pressure and thus acts as a check valve, such that only a very small leakage, if any at all, can occur.

Preferably, the area spanned by the third sealing element 32 is significantly larger than the area of the second sealing element 30 or the area of the first sealing element 8.

With an assumed nozzle area of (20−2) mm² for the check valve (30, 32), the pressure drop is reduced by a factor of 9 to 0.1 N/18 mm²=56 hPa. The sealing line force is reduced here merely by the acceptable factor of 3.2 to 0.1 N/16=0.006 N/mm. In the case of the nozzle area, the area of the filling valve and of the supply opening 3 was deducted, since the force acting thereon is absorbed via the plunger 11 and thus does not act on the check valve (30, 32).

As a result, the same elastic element 10 can be used for the (identical) restoring force of the venting valve and check valve (30, 32). In this case, the restoring force can be generated by a separate spring (e.g. spiral spring) or by the internal material stress of an elastic overall sealing element for the check valve (e.g. spherical cap, see below).

The pressure in the cushion or in the air chamber 2 additionally increases the sealing force of the check valve and thus reduces the remaining leakage, particularly at a high cushion pressure.

FIGS. 2 to 4 show the pneumatic valve of FIG. 1 in an enlarged illustration of the part with the air chamber 2 and the movable closing element 7 and also the sealing elements 8, 30, 32 and sealing seats 9, 31, 33 in various states.

In FIGS. 2 to 4, identical parts are provided with the same reference signs as in FIG. 1, but, for reasons of clarity, only the essential reference signs are shown, and different—in particular related—reference signs are shown in the various figures.

In FIG. 2, the pneumatic valve is shown in the same state as in FIG. 1. The supply opening 3 is closed by the second sealing element 30 and the discharge opening 5 is opened up by the first sealing element 8, such that air in a connected cushion (not illustrated) can escape via the housing interior via the connecting port 28, the connecting opening 4 and the discharge opening 5 and finally via the opening 29 in the second housing part 18.

The closing element 7 is pressed against the supply opening 3 by the actuating portion 14 of the non-activated actuator 6 owing to the spring force of the bending portion 15.

In FIG. 3, the pneumatic valve of FIG. 1 is shown in a second, activated state, thus in a state in which the supply opening 3 is open and air can flow from the supply port 27 via the connecting port 28 through the air chamber 2 into an optionally connected air cushion (not illustrated).

As a result of activation of the actuator 6, the actuating portion 14 of the actuating element 13 is raised and thus the closing element 7 is likewise pushed upward by the spring force of the elastic element 10 and the discharge opening 5 is consequently closed by the first sealing element 8. The closing element 7 no longer presses on the second sealing element 30, and therefore the latter is raised together with the third sealing element 32 by the air pressure and opens the supply opening 3. Here, in a manner according to the invention, the third sealing element 32 is arranged downstream of the second sealing element 30 in relation to the flow direction.

Lastly, FIG. 4 shows a third state of the valve in which, when the actuator 6 is activated and the first sealing element 8 closing the discharge opening 5 functions as a check valve, the third sealing element 32 closes the supply opening 3, since the air pressure at the connecting opening 4 or in the air chamber 2 is higher than at the supply opening 3 or the supply port 27. The second sealing element 30 is lifted from the second sealing seat 31 with the plunger 11 by the spring force of the elastic element 10—a spiral spring in the illustrated exemplary embodiment.

A second embodiment of a pneumatic valve is illustrated in FIGS. 5 to 7. Here, too, the same parts as in FIGS. 1 to 4 are provided with the same reference signs, with not all of the reference signs being shown in each figure for reasons of clarity.

In the second embodiment, the second sealing element is in the form of an inner region of a spherical cap 35 and lies between the closing element 7 and the supply opening 3, in a substantially freely movable manner at least between these parts.

The spherical cap 35 furthermore comprises the third sealing element, which forms the outer region thereof. The region of the spherical cap 35 between the outer and the inner region is formed by the elastic connection. The spherical cap 35 thus forms an overall sealing element, the individual mentioned regions of which have different functions. In particular, owing to its spherical cap shape, this overall sealing element also has the function of the elastic element, and therefore a spiral spring, for example, can be dispensed with. The spherical cap 35 has this spring function on account of its shape and, when the actuator 6 is activated, can push the closing element 7 against the discharge opening 5 and thus press the first sealing element 8 against the first sealing seat 9.

The same three states as in FIGS. 2 to 4 are illustrated in FIGS. 5 to 7, the difference residing only in the design of the second and third sealing elements 30, 32.

The advantages of the mentioned embodiments result from a halved number of actuators compared with an arrangement having 3/3-way NO switching valves with comparable function for massage applications, from a cost-effective, space-saving and weight-reducing presentation of a massage with holding function and from a partial compensation of pressure loss, in the event that during a longer holding time of the valve a leak occurs at the check valve, during which further cushions are intended to be filled.

1. A pneumatic valve, having a housing in which an air chamber with a supply opening for supplying compressed air into the air chamber, a connecting opening for connecting the air chamber to an air cushion and a discharge opening for discharging compressed air from the air chamber is formed,
wherein an actuator with a movable closing element is arranged in the housing,
wherein the closing element is formed with a plunger, which projects through the discharge opening and has formed at the that portion thereof projecting into the air chamber a plate on which a first sealing element for closing the discharge opening is arranged, and with an elastic element which, in the an activated state of the pneumatic valve, presses the first sealing element against the discharge opening,
wherein the actuator also has:
a circuit board,
an actuating element which has an actuating portion for acting on the plunger and a bending portion connected to the actuating portion and to the circuit board, and
an actuator element which has a first end mechanically connected to the actuating portion and a second end mechanically and electrically connected to the circuit board,
wherein the actuator element is designed to, in a non-energized state, bring the actuating element to a first state in which it presses the plunger against the supply opening, and to, in an energized state, bring the actuating element to a second state in which the actuating portion does not exert any force on the plunger resulting in the discharge opening being closed by the first sealing element owing to an action of the elastic element,
wherein a second sealing element is arranged in the air chamber, said second sealing element, in the non-energized state of the actuator element, closing the supply opening and, in the energized state of the actuator element, opening the supply opening in case of a positive pressure difference between pressure at the supply opening and pressure at the connecting opening,
wherein a third sealing element is arranged in the air chamber, said third sealing element being elastically connected to the second sealing element and being arranged downstream of the second sealing element in a flow direction of the compressed air from the supply opening to the connecting opening,
wherein the elastic element acts directly on the third sealing element and via the elastic connection on the second sealing element,
and wherein the third sealing element closes the supply opening in case of a non-positive pressure difference between the pressure at the supply opening and the pressure at the connecting opening.

2. The pneumatic valve as claimed in claim 1, wherein the second sealing element closes the supply opening by being pressed against a second sealing seat.

3. The pneumatic valve as claimed in claim 1, wherein the third sealing element is assigned to a third sealing seat on the housing, which third sealing seat is arranged concentrically with respect to a second sealing seat on the housing and runs around the second sealing seat.

4. The pneumatic valve as claimed in claim 1, wherein area spanned by the third sealing element is significantly larger than area of the second sealing element or area of the first sealing element.

5. The pneumatic valve as claimed in claim 1, wherein the elastic element is a spiral spring.

6. The pneumatic valve as claimed in claim 1, wherein the elastic connection is formed by a bead of U-shaped cross section which runs around the second sealing element and runs within the third sealing element.

7. The pneumatic valve as claimed in claim 1, wherein the second sealing element, the third sealing element and the elastic connection thereof are formed integrally as a spherical cap.

8. The pneumatic valve as claimed in claim 2, wherein the third sealing element is assigned to a third sealing seat on the housing, which third sealing seat is arranged concentrically with respect to the second sealing seat on the housing and runs around the second sealing seat.

9. The pneumatic valve as claimed in claim 8, wherein area spanned by the third sealing element is significantly larger than area of the second sealing element or area of the first sealing element.

10. The pneumatic valve as claimed in claim 9, wherein the elastic element is a spiral spring.

11. The pneumatic valve as claimed in claim 10 wherein the elastic connection is formed by a bead of U-shaped cross section which runs around the second sealing element and runs within the third sealing element.

12. The pneumatic valve as claimed in claim 9, wherein the elastic connection is formed by a bead of U-shaped cross section which runs around the second sealing element and runs within the third sealing element.

13. The pneumatic valve as claimed in claim 9, wherein the second sealing element, the third sealing element and the elastic connection thereof are formed integrally as a spherical cap.

14. The pneumatic valve as claimed in claim 8, wherein the elastic element is a spiral spring.

15. The pneumatic valve as claimed in one claim 8, wherein the elastic connection is formed by a bead of U-shaped cross section which runs around the second sealing element and runs within the third sealing element.

16. The pneumatic valve as claimed in claim 8, wherein the second sealing element, the third sealing element and the elastic connection thereof are formed integrally as a spherical cap.

17. The pneumatic valve as claimed in claim 2, wherein area spanned by the third sealing element is significantly larger than area of the second sealing element or area of the first sealing element.

18. The pneumatic valve as claimed in claim 2, wherein the elastic element is a spiral spring.

19. The pneumatic valve as claimed in claim 2, wherein the elastic connection is formed by a bead of U-shaped cross section which runs around the second sealing element and runs within the third sealing element.

20. The pneumatic valve as claimed in claim 2, wherein the second sealing element, the third sealing element and the elastic connection thereof are formed integrally as a spherical cap.
